(19) United States
(12) Patent Application Publication
(10) Pub. No.: US 2002/0079211 A1
(43) Pub. Date: Jun. 27, 2002

(54) Key switch with click elastic member placed between key top and switch element

(76) Inventors: Katsuyuki Katayama, Fukushima-ken (JP); Masaaki Kageyama, Fukushima-ken (JP); Satoru Takemori, Fukushima-ken (JP)

Correspondence Address: BRINKS HOFER GILSON & LIONE, N B C TOWER, SUITE 3600, 455 N. CITYFRONT PLAZA DR., CHICAGO, IL, 60611, US

(21) Appl. No.: 09/907,470

(22) Filed: Jul. 17, 2001

(30) Foreign Application Priority Data
Jul. 17, 2000 (JP) 2000-216203

(51) Int. Cl. H01H 13/70

(52) U.S. Cl. 200/517

(57) ABSTRACT

There will be provided a key switch in which the electrically-conductive pattern of the switch element is not oxidized, nor is patterning of the electrically-conductive pattern restricted.

A key switch provided with: a key top 1 supported so as to be able to move up and down; a click elastic member 8 for biasing the key top 1 upwardly; and a switch element 7 disposed below the click elastic member 8, for performing a switching operation through the click elastic member 8 with an up-and-down operation of the key top 1, wherein the click elastic member 8 has a dome-shaped buckling portion 8b opened toward the key top 1 side, and a barrel-shaped pressing portion 8c provided in a lower part of the buckling portion 8b, and opened toward the switch element 7 side.

### BACKGROUND OF THE INVENTION

1. Field of the Invention

The present invention relates to a key switch for use with a keyboard input device, and more particularly to a key switch with a click elastic member placed between a key top and a switch element.

2. Description of the Related Art

In recent years, as a key switch suitable for making a keyboard input device thin, there has been proposed a key switch constructed such that a key top is supported by upper end portions of a pair of levers link-combined so as to intersect each other and that an angle, at which the pair of levers intersect, changes with an up-and-down operation of the key top.

There has been proposed, for example, a key switch constructed such that there is used a cross-link body comprising one lever, the upper end portion of which is freely pivotally engaged with the back surface of the key top, and the other lever, the upper end portion of which is freely slidably engaged with the back surface of the key top, link-combined at their intersecting region, and that the cross-link body guides the up-and-down operation of the key top.

When an operator depresses the key top, the pair of levers incline and fall to press and fold up the cross-link body. At a point of time whereat the key top lowers by a predetermined amount, an elastic body such as click rubber is pressed by the key top to be buckled, and therefore, a switch element such as a membrane sheet is pressed in by the elastic member to turn the switch on.

Also, when a pressing operation force onto the key top is removed in a switch-ON state, the elastic member, which has been buckled, returns to its original state by its own elasticity, and therefore, the switch element returns to the OFF state, and the key top is raised to the initial position while the pair of levers, which have been inclined and fallen, are being caused to stand up.

When there is adopted such structure as to support the key top so as to be able to move it up and down by means of the cross-link body in this manner, there are advantages that satisfactory operability is secured and the height of the switch can be greatly reduced as compared with a general key switch for sliding a key stem along the guide wall.

FIG. 5 is a sectional view showing click rubber, a membrane sheet and a holding plate which have been conventionally used. The click rubber 100 is substantially shaped like a bowl turned inside out, at the top thereof, there is provided a barrel-shaped receiving portion 101 for receiving the key top, at the lower part thereof, there is contiguously provided a dome-shaped buckling portion 102, and at a joining area between the receiving portion 101 and the buckling portion 102, there is formed a protruded portion 103 for protruding downward.

Under the click rubber 100, there are disposed a membrane sheet 104 and a holding plate 105 for supporting it, and the click rubber 100 is bonded and fixed onto the membrane sheet 104.

When the key top (not shown) is disposed on the receiving portion 101 of the click rubber 100 and is depressed in a direction indicated by an arrow, the click rubber 100 is crushed to buckle the peripheral wall of the buckling portion 102 inwardly so that the protruded portion 103 presses the membrane sheet 104 to turn the switch on. When the pressing force onto the key top is removed in this state, the click rubber 100, which has been buckled, returns to its original shape by means of its restoration force so that the protruded portion 103 leaves the membrane sheet 104 to return the membrane sheet 104 to the OFF state.

This click rubber 100 is provided with the buckling portion 102 in the lower part thereof, and since the buckling portion 102 is reliably buckled, large space 106 is formed inside, and an underside of the buckling portion 102 is bonded to the membrane sheet 104.

This bonding causes the space 106 to become a hermetically-sealed space portion, and since when the click rubber 100 is pressed, air within the space 106 has its escape cut off and is compressed for that reason, the protruded portion 103 cannot sufficiently lower, but the pressing onto the membrane sheet 104 becomes unreliable. Also, even if the protruded portion 103 sufficiently lowers, when the pressing force onto the key top is removed, it takes time for the click rubber 100 to return to its original state from its buckled state so that operation reliability poses a problem.

In order to solve this problem, there has been adopted means for communicating the space 106 to the outside by forming parts of the membrane sheet 104 and the holding plate 105 with an air hole 107 as shown in FIG. 5. If arranged in such a way, the click rubber 100 will be smoothly buckled and returned from the buckled state to the original shape, but there still remain problems.

More specifically, the air hole 107 is formed to communicate the space portion 106 to the outside, whereby the water-proofness and dust-proofness are deteriorated, an electrically-conductive pattern formed within the membrane sheet 104 is oxidized to increase the contact resistance, and it is necessary to form the electrically-conductive pattern by avoiding the air hole 107, and for this reason, there are inconveniences such as patterning to be restricted.

### SUMMARY OF THE INVENTION

It is an object of the present invention to overcome such drawbacks of the prior art, and to provide a key switch, in which an electrically-conductive pattern of the switch element is not oxidized, nor is patterning thereof restricted.

In order to achieve the above-described object, the present invention aims at a key switch provided with: a key top supported so as to be able to move up and down; a click elastic member such as, for example, click rubber for biasing the key top upwardly; and a switch element disposed below the click elastic member, such as, for example, a membrane sheet for performing a switching operation through the click elastic member with the up-and-down operation of the key top.

The click elastic member is characterized by comprising: a dome-shaped buckling portion opened toward the key top side; and a barrel-shaped pressing portion provided in a lower part of the buckling portion, opened toward the switch element side.

### BRIEF DESCRIPTION OF THE DRAWINGS

FIG. 1 is a sectional view showing click rubber according to an embodiment of the present invention;

FIG. 2 is a sectional view showing a key switch, to which the click rubber has been installed;

FIG. 3 is a side sectional view showing part of the key switch;

FIG. 4 is a sectional view showing a variation of the switching unit; and

FIG. 5 is a sectional view showing conventional click rubber, membrane sheet and holding plate.

### DESCRIPTION OF THE PREFERRED EMBODIMENTS

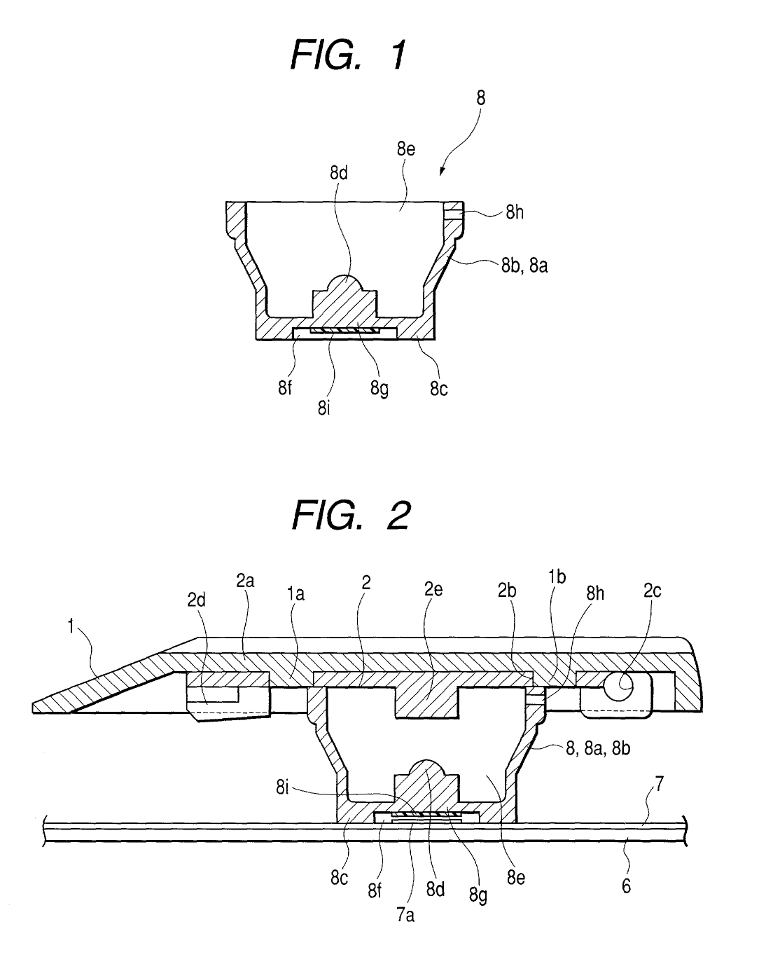

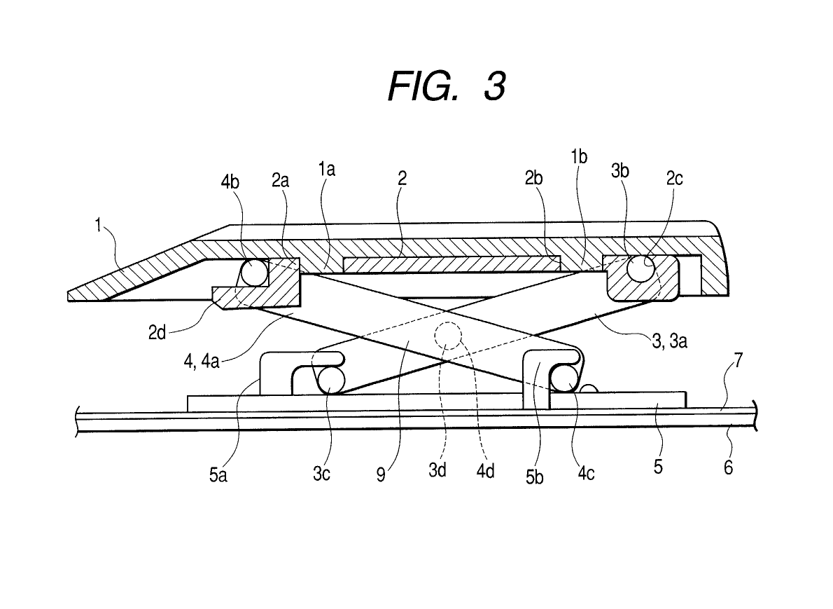

Hereinafter, with reference to the drawings, the description will be made of embodiments according to the present invention. FIG. 1 is a sectional view showing click rubber according to an embodiment of the present invention, FIG. 2 is a sectional view showing a key switch, for which the click rubber has been used, and FIG. 3 is aside sectional view showing part of the key switch.

The key switch according to this embodiment is mainly constructed of: the key top 1; an actuator 2 for locking the other side of the key top 1; an inside lever 3 and an outside lever 4 which are supporting the key top 1 through the actuator 2 so as to be able to move up and down; a plate 5 for supporting the levers 3 and 4 by mounting them; a holding plate 6 for locking the plate 5 by mounting it; a membrane sheet 7 for performing a switching operation with the up-and-down operation of the key top 1; and click rubber 8, mounted on top of the membrane sheet 7, for biasing the key top 1 upwardly through the actuator 2. This key switch is disposed in a keyboard input device.

The description will be made of the structure of each portion of the key switch. On the other side of the key top 1, there are formed a pair of protruded portions 1a and 1b, the actuator 2 is formed with a pair of locking holes 2a and 2b, and the protruded portions 1a and 1b are pressed into the locking holes 2a and 2b respectively, whereby the key top 1 and the actuator 2 are made integral.

At one end portion of the actuator 2, there is formed a shaft groove 2c for pivotally engaging the upper end portion of the inside lever 3, while at the other end portion, there is formed a trap portion 2d for slidably engaging the upper end portion of the outside lever 4. At the central portion of the base of the actuator 2, there is formed a protruded portion 2e for pressing the central portion inside the click rubber 8.

The inside lever 3 is formed in a frame shape such that rotating shafts 3b are provided on the side of upper ends of a pair of inclining leg portions 3a and that on the lower end side, slide pins 3c are projectingly provided, and at the center of the outside surface of each inclining leg portion 3a, there is formed a coupling shaft 3d for projecting sideways. As shown in FIG. 3, the rotating shaft 3b of the inside lever 3 is pivotally engaged with the shaft groove 2c of the actuator 2, and the slide pin 3c is slidably engaged with a first raised-up portion 5a of the plate 5.

The outside lever 4 is formed in a U-character-shape such that there is provided a slide shaft 4b on the upper end side of a pair of inclining leg portions 4a and that a rotating pin 4c is projectingly provided on the lower end side. The slide shaft 4b is slidably engaged with the trap portion 2d of the actuator 2, and the rotating pin 4c is pivotally engaged with a second raised-up portion 5b of the plate 5.

The coupling shaft 3d of the inside lever 3 is pivotally inserted into a shaft-inserting hole 4d of the outside lever 4, whereby the levers 3 and 4 are pivotally coupled with each other at their intersection to constitute a cross-link body 10. The cross-link body 10 changes its height in accordance with an angle of inclination of the inclining leg portions 3a and 4a of the both levers 3 and 4.

The plate 5 is formed of a metallic plate by means of press working, and is formed with the first raised-up portion 5a, the second raised-up portion 5b and an aperture (not shown) through which the click rubber 8 is inserted. The raised-up portions 5a and 5b have substantially L-character-shaped sides, and are directed opposite in direction to each other. The cross-link body 10 is mounted onto the plate 5 so as to be able to incline, and inside the cross-link body 10, there is disposed click rubber 8, and on the upper portion of the cross-link body 10, there is placed the key top 1 through the actuator 2.

The membrane sheet 7 is a sheet having a fixed electrode 7a on the top surface, and above the fixed electrode 7a, there is bonded and disposed the click rubber 8 having a movable electrode 8i in such a manner that the membrane sheet 7 and the click rubber 8 constitute a switching unit.

The click rubber 8 shaped like a bowl turned inside out is placed on the switching unit of the membrane sheet 7 in a state in which the upper end surface of the click rubber 8 abuts upon the underside of the actuator 2. The click rubber 8 has a dome-shaped buckling portion 8b opened toward the key top 1 side, having a bent peripheral wall 8a in the top part thereof, a barrel-shaped pressing portion 8c opened toward the membrane sheet 7 side and a receiving portion 8d protruding upwardly on top of the pressing portion 8c, and the three are integrally formed. First space 8e to be formed by the buckling portion 8b has a far larger space portion than second space 8f to be formed by the pressing portion 8c. In the vicinity of the aperture of the buckling portion 8b, there is formed an air hole 8h for penetrating the peripheral wall.

In the present embodiment, the click rubber 8 has been provided with the air hole 8h, but it is also possible to form the key top 1 or (and) the actuator 2 with a groove for communicating the first space 8e to the outside instead of providing the air hole 8h.

As shown in FIG. 2, the receiving portion 8d is disposed between the actuator 2 and the membrane sheet 7 in such a manner that the receiving portion 8d opposes to the protruded portion 2e of the actuator 2, and that the pressing surface 8g provided on the top surface of the pressing portion 8c, formed with the movable electrode 8i opposes to the fixed electrode 7a of the membrane sheet 7.

Next, the description will be made of an operation of this key switch. When the operator depresses the key top 1 in the switch-OFF state shown in FIGS. 2 and 3, the inclining leg portions 3a and 4a of the pair of levers 3 and 4 incline and fall with the lowered actuator 2 to press and fold up the cross-link body 9. At a point of time whereat the key top 1 lowers by a predetermined amount, the buckling portion 8b (bent peripheral wall 8a) of the click rubber 8, which has been pressed by the actuator 2, buckles toward the inside, and the protruded portion 2e of the actuator 2 bumps against the receiving portion 8d of the click rubber 8. When the key top 1 is further pressed in, the pressing portion 8c (pressing surface 8g) is pressed and warped by means of the protruded portion 2e of the actuator 2 so that the fixed electrode 7a of the switching unit comes into contact with the movable electrode 8i to turn the switch on.

When the pressing force onto the key top 1 is removed in the switch-ON state, the click rubber 8, which has been buckled, returns to the original shape by means of the elasticity of its own, and therefore, the movable electrode 8i leaves the fixed electrode 7a to return to the switch-OFF state, and the actuator 2 is thrust up. Thereby, the cross-link body 9 stands up to also thrust up the key top 1 to the initial position shown in FIGS. 2 and 3.

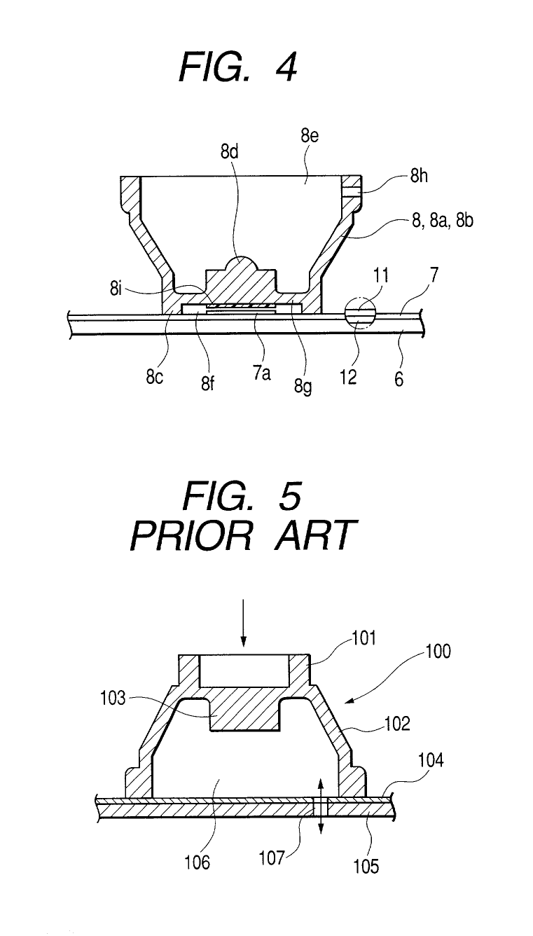

FIG. 4 is a view showing a variation of the switching unit. In the case of this example, the membrane sheet 7 is constructed to interpose a spacer between an upper sheet 11 having an upper electrode in the underside and a lower sheet 12 having a lower electrode in the upper surface, and the upper electrode and the lower electrode constitute the switching unit. Depressing the key top 1 buckles the buckling portion 8b (bent peripheral wall 8a), and the protruded portion 2e of the actuator 2 presses the pressing portion 8c (pressing surface 8g) against the membrane sheet 7 side to be warped so that the upper electrode comes into contact with the lower electrode to turn the switch on.

In the above-described embodiment, there has been used the click elastic member made of rubber, but it is also possible to use a click elastic member made of synthetic resin rich in flexibility.

According to the present invention, it is not necessary to provide the switch element side with any air hole for communicating to internal space within the buckling portion unlike the conventional case because of the above-described structure, and for the reason, it is possible to provide a key switch in which the electrically-conductive pattern of the switch element is not oxidized, nor is patterning of the electrically-conductive pattern restricted.

What is claimed is:

1. A key switch, comprising:
a key top supported so as to be able to move up and down;
a click elastic member for biasing the key top upwardly; and
a switch element disposed below the click elastic member, for performing a switching operation through the click elastic member with an up-and-down operation of the key top, wherein
the click elastic member has a dome-shaped buckling portion opened toward the key top side, and a barrel-shaped pressing portion provided in a lower part of the buckling portion, opened toward the switch element side.

2. A key switch according to claim 1, wherein first space to be formed by the buckling portion is larger than second space to be formed by the pressing portion.

3. A key switch according to claim 1, wherein on top of the pressing portion, there is formed a receiving portion for protruding toward the key top side.
